(19) United States
(12) Patent Application Publication
(10) Pub. No.: US 2026/0346523 A1
(43) Pub. Date: Nov. 5, 2026

(54) METHOD FOR MANUFACTURING A SHEET FLOORING PRODUCT, AND SHEET FLOORING PRODUCT OBTAINABLE THEREBY

(71) Applicant: UNILIN, BV, Wielsbeke (BE)

(72) Inventor: Kristof VAN VLASSENRODE, Wielsbeke (BE)

(21) Appl. No.: 19/487,053

(22) PCT Filed: Jun. 6, 2024
(86) PCT No.: PCT/IB2024/055520

§ 371 Date: Nov. 24, 2025

Related U.S. Application Data
(60) Provisional application No. 63/507,742, filed on Jun. 13, 2023.
(60) Provisional application No. 63/513,132, filed on Jul. 12, 2023.

(51) Int. Cl. B29C 48/00; B29C 48/07; B29K 27/06; B29K 105/04; B29L 7/00; E04F 15/10

(52) U.S. Cl. CPC B29C 48/0021; B29C 48/0012; B29C 48/07; E04F 15/105; E04F 15/107; B29K 2027/06; B29K 2105/04; B29L 2007/002

(57) ABSTRACT

A method is for manufacturing a sheet flooring product. The sheet flooring product includes a substrate layer and a provided thereon decorative top layer. The method at least includes the step of providing the substrate layer on the basis of polyvinyl chloride of the suspension grade.

The present invention relates to a method for manufacturing a floor covering material, in particular a sheet vinyl flooring product.

More particularly, the invention relates to a floor covering material of the so-called “cushion vinyl” type. Such floor covering material is widely known, for example, from CA 1 046 869 and WO 2005/118947. Herein, this may relate to a web-shaped floor covering material which is supplied from a roll. In a room a plurality of webs cut to length can be installed next to each other, for example, by gluing the respective webs at their edges onto the subfloor or onto the underlying floor. Floor covering material of the “cushion vinyl” type can be composed of a carrier layer or liner, on which a foamed layer is situated, namely, the actual cushion vinyl layer. This foamed layer as such can consist of one or more sublayers. On the foamed layer a printed decor is situated. The printed decor either can be applied as a foil printed beforehand, for example, a printed PVC foil, or can be formed directly on the foamed layer, for example, with the intermediary of suitable primers and other basic layers, such as layers on the basis of PVC plastisol. On the upper side, the printed decor is protected by a transparent wear layer, which also can be based on PVC (Polyvinyl chloride). Possibly, a superficial lacquer based on acrylate, urethane acrylate or polyurethane can be present on the surface of the wear layer.

PVC plastisol comprises very fine particles of emulsion grade PVC that are emulsified in plasticizer. The present methods of manufacturing sheet vinyl flooring heavily depend on the rheology of the applied PVC plastisol. The rheology of a PVC plastisol can easily be disturbed when incorporating recycled material content therein. Particles of recycled PVC may not have the fine particle size of emulsion grade PVC and the remaining contaminations in the recycled PVC and/or plasticizer content may adapt the rheology to an unacceptable extent.

The present invention primarily aims at offering an alternative method for manufacturing a PVC sheet floor covering material, wherein according to various preferred embodiments solutions are offered to the problems with the methods of the state of the art. In particular a sheet flooring product is obtained which has a larger potential for incorporation of recuperated materials, such as recycled PVC powder and recycled plasticizer.

To this aim, the invention, according to its first independent aspect, is a method for manufacturing a sheet flooring product, wherein said sheet flooring product comprises a substrate layer and, preferably a provided thereon decorative top layer, with the characteristic that said method at least comprises the step of providing said substrate layer using, or on the basis of, polyvinyl chloride of the suspension grade. Due to the fact that polyvinyl chloride of the suspension grade is used, a scala of opportunities is provided for incorporation of recycled materials in the sheet flooring product. For example, recycled PVC obtained from the recycling of sheet vinyl products may be provided in a particle size that can be mixed into virgin PVC of the suspension grade without interference or with a minimal interference with the material quality. Plasticizers extracted from PVC scrap, for example by means of solvents, supercritical CO₂ or ionic liquids, may be used in said substrate layer, and/or filler materials obtained from recycling scrap materials may be applied.

It is noted that in the absence of a decorative top layer the obtained sheet flooring product may for example serve as an underlayment for a finishing floor covering material. It is also possible that the substrate layer in itself has a decorative nature, such that no separate decorative top layer is required for use as a finish floor covering material. Preferably, however, a decorative top layer is provided on said substrate layer, and the sheet flooring product of the invention is for use a finish floor covering material.

Preferably, said sheet flooring product comprises a liner, wherein said step of providing said substrate layer comprises applying said polyvinyl chloride of the suspension grade on said liner. The liner may function as a carrier layer for said sheet flooring product and/or may reinforce the obtained sheet flooring product. Said reinforcement may limit the dimensional instability of the sheet flooring product in changing ambient climates, and/or may limit puncturing and tearing.

Preferably said liner is a textile, for example a woven or non-woven textile. The filaments of said textile may be glass fibers, PVA (polyvinyl acetate) fibers or carbon fibers.

Preferably said substrate layer forms at least half the thickness of said sheet flooring product, or at least 75% of the thickness of said sheet flooring product. Preferably, said sheet flooring product consists of said decorative top layer, said substrate layer and potentially a textile backing applied to the side of said substrate layer opposite said decorative top layer.

Preferably, said polyvinyl chloride contained in the substrate layer is mainly polyvinyl chloride of the suspension grade. It is however not excluded that said substrate layer may comprise one or more sublayers on the basis of polyvinyl chloride of the emulsion grade. Preferably, however, the cumulative thickness of sublayers based on polyvinyl chloride of the emulsion grade is less then the cumulative thickness of sublayers based on polyvinyl chloride of the suspension grade. The presence of one or more sublayers based on polyvinyl chloride of the emulsion grade may lead to several practical embodiment, of which here below four practical embodiment are further elucidated without desiring to be exhaustive.

According to a first practical embodiment, the decorative top layer comprises a printed pattern, and one or more sublayers based on polyvinylchloride of the emulsion grade are applied to form a preparatory or priming layer for direct application of inks on the substrate layer by means of roller printing or inkjet printing. In such case, the sublayer preferably is situated as an outermost sublayer of said substrate layer, adjacent to said decorative top layer.

According to a second practical embodiment, the surface of the decorative top layer comprises a texture, and one or more sublayers based on polyvinylchloride of the emulsion grade are applied to form a chemically embossable sublayer. In such case, the sublayer preferably comprises a foaming agent and/or is situated as an outermost sublayer of said substrate layer, adjacent to said decorative top layer. For example, such sublayer may be differentially foamed by patterned application of a foaming inhibitor and/or foaming promotor to thereby yield at least a portion of said texture. Said application of said foaming inhibitor or foaming promotor may be executed by means of roller printing or by means of inkjet printing. The application may be on top of the respective sublayer, or may be executed on the underlying sublayer before application of the respective sublayer. The activation of said foaming agent and the differential foaming leading to at least a portion of said texture is preferably obtained by means of heat, for example in an oven, preferably a hot air oven.

According to a third practical embodiment, a sublayer of polyvinylchloride of the emulsion grade is present in between two sublayers based on said polyvinyl chloride of the suspension grade. In such case, for example, an additional attenuation of walking sounds and/or additional walking comfort can be attained.

According to a fourth practical embodiment, a sublayer of polyvinylchloride of the emulsion grade is present as an outermost sublayer of said substrate layer at the surface thereof which is opposite to said decorative top layer. In such case, for example, additional levelling properties may be obtained and/or additional walking comfort and/or additional attenuation of walking sounds.

It is of course possible that the features of any two, three or all of the above practical embodiments are combined.

The provision of said substrate layer using, or on the basis of, said polyvinyl chloride of the suspension grade may be executed in accordance with numerous possibilities, of which here below three possibilities are further described without aiming to be exhaustive.

According to a first possibility, said step of providing said substrate layer comprises extruding said polyvinyl chloride of the suspension grade through one or more slot nozzle dies, preferably of the coat-hanger type, or, alternatively, of the T-type. Slot nozzle dies may be used to create an applied layer of said polyvinyl chloride of limited thickness, for example of 0.5 to 2 mm. “Coat-hanger type” or “T-type” refers to the shape of the internal manifold of the respective die, i.e. to how the extruded material is spread from the inlet of the die, i.e. from the initial extrusion channel connected to the extruder, towards the slot nozzle opening. In a T-type die, the manifold comprises two arms extending at about 90° angles from the initial extrusion channel. These arms have a small slit along their length to allow the polymer melt to flow through towards the die opening. In a coat-hanger type die, the manifold comprises two arms that extend at a shallower angle from the initial extrusion channel and these arms may be straight or curved. The channels formed by the arms may have a diameter tapering down to a smaller radius further from the input channel, in which case the coat-hanger type die may be referred to as a fish tail type die.

In said first possibility, said die of the coat-hanger type, for example said fish tail type die, is preferred, as it is able to create a more uniform thickness or mass flow over the width of the slot nozzle opening than a T-type die. Especially with widths of the sheet flooring product exceeding 2 meters, such as 2.5 m or more, the uniformity of application of PVC delivered by a die of the coat-hanger type is of particular interest. Preferably, said die of the T-type is used to manufacture sheet flooring product having a width of 2.5 m or less. Alternatively two or more dies of the T-type may be applied in parallel to yield a sheet flooring product having a width exceeding 2 meters, such as 2.5 m or more.

Said one or more dies may comprise a measurement device for measuring the slot nozzle opening. Such measurement device may make use of the capacitive and/or inductive measuring principle for measuring the distance between the lips bordering the slot nozzle opening, while the material is being extruded. The measurement may be direct or indirect. With a “direct measurement” it is meant that the distance between the lips bordering the slot nozzle is measured. With an “indirect measurement” it is meant that a different dimension linked to the distance between said lips is measured. For example, said lips may comprise one flexible lip and one rigid lip, wherein a measurement of the deflection of said flexible lip with respect to a rigid portion of the die, other than said rigid lip, may then be correlated to the distance between said flexible lip and said rigid lip. Such indirect measurement may also be performed in case said slot nozzle opening is bordered by means of two flexible lips, wherein then a measurement of the deflection of both flexible lips is preferred.

Said one or more dies may comprise a, preferably motorized and controlled, mechanism for adjustment of the slot nozzle opening. For example such die may have a slot nozzle opening which is bordered by at least one flexible lip, wherein said flexible lip may be displaced by means of a plurality of actuators along the width of said lip, i.e. in a direction along the width of the slot nozzle opening. Preferably some, i.e. at least two, or all of said actuators may be adjusted independently of one another, such that the flexible lip may be displaced with varying amounts along said width of the slot nozzle opening.

Preferably, the thickness and/or density and/or uniformity of the extruded material leaving the slot nozzle opening is measured, for example using NIR or X-ray. On the basis of the measurement of the thickness and/or density and/or uniformity of the extruded material the slot nozzle opening may be adjusted by an operator, and/or automatically in case the die has a suitable mechanism for adjustment of the slot nozzle opening, such as a mechanism comprising a plurality of actuators for displacement of a flexible lip bordering the slot nozzle opening, for example the mechanism as described above.

Said one or more dies may be fed by one or more extruders. Preferably, said one or more extruders are twin screw extruders, i.e. parallel or conical twin screw extruders. Of course, it is not excluded to use single screw extruders, or multiple rotating screw extruders.

According to a special embodiment, a die, for example a coat-hanger die, is fed by means of two or more extruders, or, in other words, said step of providing said substrate layer comprises extruding said polyvinyl chloride of the suspension grade through a slot nozzle die, while said slot nozzle die is fed by at least two extruders. In such case a higher mass flow may be obtained in the die and at the slot nozzle opening, such that a higher extrusion speed can be obtained. It is also possible that at least two extruders feeding the die provide a mutually different polyvinyl chloride composition at the inlet of the die, namely a first and a second composition. It is also possible that the die has at least two separate inlets, namely a first inlet for said first composition and a second inlet for said second composition. Preferably, the die is shaped such that at the nozzle opening a layered material is obtained with at least one layer of a first composition and one layer of a second composition. In other words, this concerns the coextrusion of said first and second composition. According to a first practical embodiment, a single layer of each composition is available in said layered material. This may shortly be referred to as an A-B layer configuration, where A refers to a layer having the first composition and B refers to a layer having the second composition. According to a second practical embodiment, a single layer of a second composition is obtained in said layered material, while one layer of the first composition is available at both surfaces of said single layer of said first composition. This may shortly be referred to as an A-B-A layer configuration.

The difference between said first and second composition may at least comprise:
a difference in plasticizer content, for example a difference of at least 5 phr, at least 10 phr, or at least 15 phr, wherein either the first composition or the second composition in the A-B or A-B-A configuration may have the highest plasticizer content, depending on the desired characteristics of the resulting substrate layer for the sheet flooring product. For example, when the first composition, i.e. the A-layer, has the highest plasticizer content an enhanced embossing ability, walking comfort and attenuation of walking sounds may be obtained. Because of the less plasticized second composition an enhanced resistance to puncturing and tearing may be obtained. When the second composition, i.e. the B-layer, has the highest plasticizer content an enhanced flexibility and rollability of the floor covering material may be obtained;
a difference in foaming agent content, or in foaming grade; for example one composition may be free of foaming agent, while the other composition comprises foaming agent, or one composition may lead to a foam with a foaming grade of at least 10%, while the other composition is unfoamed or leads to a foam with a foaming grade of 5% or lower. Herein either the first composition or the second composition in the A-B or A-B-A configuration may have the highest content of foaming agent, and/or may be foamed at the highest foaming grade, depending on the desired characteristics of the resulting substrate layer for the sheet flooring product. Similar advantages may be obtained as explained in relation to the possible difference in plasticizer; and/or
a difference in filler content; for example one composition may comprise 150 phr of filler, while the other composition comprises less than 150 phr of filler. Herein either the first composition or the second composition in the A-B or A-B-A configuration may have the highest content of filler, depending on the desired characteristics of the resulting substrate layer for the sheet flooring product. For example, when the first composition, i.e. the A-layer, has the lowest filler content, the higher content of the second composition, i.e. the B-layer, may lead to an easier installation. Due to the added weight of the B-layer the sheet flooring product may be laid flat with less efforts. When the first composition has the highest filler content an enhanced resistance to indentation may be obtained, in particular when the second composition is foamed to a higher foaming grade than the first composition, which may be unfoamed; and/or
a difference in recycled material content; for example one composition may comprise at least 25 parts of recycled PVC per hundred of the total PVC resin in the respective composition, while the other composition comprises less recycled PVC, as expressed in parts per hundred of the total PVC resin in this other composition. The other composition may even be free of recycled PVC. According to another example, one composition may comprise plasticizer recuperated from PVC scrap, for example by means of solvent extraction, potentially by means of supercritical CO₂, while the other composition may be free from plasticizer or only comprise virgin plasticizer. Herein either the first composition or the second composition in the A-B or A-B-A configuration may have the highest content of recycled material, i.e. PVC and/or plasticizer and/or filler, depending on the desired characteristics of the resulting substrate layer for the sheet flooring product. For example, when the first composition, i.e. the A-layer, has the lowest filler content, the higher content of the second composition, i.e. the B-layer, may lead to an environmentally friendly floor with excellent surface properties. By having the recycled content in the B-layer possible contaminations due to the recycled material content have a lower risk of constraining the satisfactory use of the obtained sheet flooring product.

It is clear that, in accordance with said first possibility, the extruded layer of PVC may be deposited on a liner. In accordance with a variant, reinforcing filaments, of e.g. glass fiber, are incorporated in the extruded layer of PVC, by introducing them in the PVC before it leaves the slot nozzle opening of the die.

In said first possibility, it is possible that several slot nozzle dies in series and/or in parallel provide said PVC of the suspension grade.

An application of PVC with a plurality of parallel dies, for example two or three dies, may provide for the formation of a substrate layer having at least the width of the sum of the widths of the slot nozzle openings of the respective dies. Potentially an overlap at, or a void between, adjacent edges of parallelly extruded layers is firstly obtained and subsequently levelled out, for example by means of one or more rollers. In a practical example, the parallelly extruded layers may be fed in the nip formed by at least two rollers, for example in order to be calibrated. Preferably said plurality of parallel dies deposit the extruded material on a common liner. According to a special embodiment, the obtained substrate layer or sheet flooring product is split at or near the void or the overlap to yield several sheet flooring products of a smaller width. In such case, said calibration may be unnecessary.

An application of PVC with a plurality of serial dies, for example two of three dies, may provide for the formation of a thicker substrate layer, and/or to the formation of a substrate layer having substrate sublayers of mutually different composition. The differences in composition may be the same or similar as those described above in connection with a first and second composition being coextruded. In accordance with a special embodiment a substrate layer is created having at least two sublayers of a mutually different foaming grade, wherein the foaming grade is expressed by the density reduction obtained in the foam as compared to the respective unfoamed material. Preferably one said at least two sublayers is unfoamed, while the other is foamed at least at a foaming grade of 10%. The presence of an unfoamed sublayer in the substrate may lead to an enhanced resistance against puncturing, and may limit the telegraphing of subfloor imperfections towards the surface of the flooring product. The unfoamed sublayer may be available in between the foamed sublayer and the decorative top layer, or be distance from said decorative top layer at least by said foamed sublayer. The latter is preferred as such sheet flooring product may combine comfortable walking quality with a reduced susceptibility to telegraphy of subfloor imperfections.

It is noted that said PVC of the suspension grade may be provided by extrusion to one or more liners. In particular in the cases where a plurality of serial dies are applied, each die may be applying said PVC of the suspension grade to a respective liner.

According to a second possibility, said step of providing said substrate layer comprises the lamination of a prefabricated sheet of polyvinyl chloride of the suspension grade. The lamination may be to a further sheet of polyvinyl chloride of the suspension grade, and/or to one or more liners, and/or to said decorative top layer or a portion thereof. The lamination is preferably executed by thermal lamination, wherein one or both layers to be laminated are in a heated situation and are pressed onto each other, for example by means of one or more rollers.

In accordance with the second possibility, at least two prefabricated sheets of a mutually different composition may be laminated together, for example to yield an A-B configuration or an A-B-A configuration. The mutually different composition may be the same or similar as the potential different compositions described in connection with the first possibility.

According to a third possibility, said step of providing said substrate layer comprises the scattering of granules comprising polyvinyl chloride of the suspension grade.

According to a fourth possibility, any two or three of the first, second and third possibility are combined. For example, a first sublayer of the substrate layer may be obtained through the first possibility namely by extrusion, while a second sublayer of the substrate layer is obtained through the second possibility, namely as a prefabricated sheet. In such case the prefabricated sheet may function as a liner for application of the first sublayer by means of extrusion.

In each of the possibilities above, it is not excluded that said step of providing said substrate layer further comprises applying a layer of PVC plastisol, preferably adjacent to a substrate sublayer obtained on the basis of said polyvinyl chloride of the suspension grade, preferably in accordance with the first, second or third possibility therefor mentioned above. It is clear that such layer of PVC plastisol is then preferably based on PVC of the emulsion grade. In so doing, an example of the first, second, third and/or fourth practical embodiment listed above may be obtained.

Preferably, said step of providing said substrate layer comprises feeding at least a portion of said substrate layer through the nip of a set of rollers.

As explained in the context of said first possibility, feeding at least a portion of said substrate layer through the nip of a set of rollers may lead to a calibration of the thickness of the obtained substrate layer or portion thereof. Such treatment is not only of interest when the polyvinyl chloride is extruded. It may, for example, also be of interest when the PVC of suspension grade is provided as one or more prefabricated sheets, or as a scattered layer of PVC granules.

Preferably, said substrate layer comprises a foamed portion. The foamed portion may be obtained through chemical or physical foaming. Preferably, it is a chemically foamed portion, wherein, hereto, said polyvinyl chloride of the suspension grade comprises a blowing agent, for example azodicarbonamide. It is clear that through the present preferred embodiment a new type of cushion vinyl sheet flooring material may be obtained, which is better suited for recycling and/or in itself may be made up of a large content of recycled material, such as from recuperated plasticizer content or recuperated polyvinyl chloride content of PVC scrap materials. Such a cushion vinyl sheet flooring material may for at least 10 wt %, or at least 25 wt % be realized from recuperated materials.

It is hence clear that the step of providing said substrate layer may further comprise the substep of foaming said substrate layer or a sublayer thereof. Preferably an open-cell foam is obtained or a foam having a majority of open cells.

Preferably, said step of providing said substrate layer comprises a heat treatment of said substrate layer, preferably at least for foaming said substrate layer. The heat treatment may be followed by a cooling treatment for example in the nip between a set of cooled rollers in order to control and/or limit and/or stop the foaming.

When applying said first possibility of providing said substrate layer and in the cases where chemical foaming is applied for realizing said substrate layer, or a foamed portion or sublayer thereof, the foaming agent is preferably mixed with the PVC composition prior to the extrusion thereof. In the cases where physical foaming is applied for realizing said substrate layer, or a foamed portion or sublayer thereof, a liquefied gas, preferably liquefied CO₂ or Nitrogen, is added in the extruder barrel and mixed with the PVC composition. Alternatively, said liquefied gas may be added in the feeding block linking the extruder with the die, or in the die.

Preferably, when foaming is practiced in connection with said first possibility, the extruded material is treated in the nip of a set of rollers within a short distance from the slot nozzle opening, for example with the first 10 m, or within the first 5 m from the die opening as measured along the trajectory of the extruded material. Such treatment may lead to an enhanced control of the obtained foamed portion or sublayer. Preferably the rollers creating said nip are temperature controlled, preferably cooled.

Alternatively to said foaming, a light filler material, namely a filler having a density lower than 650 kg/m³, or lower than 300 kg/m³, may be applied such as foamed or expanded polystyrene particles. The use of light filler material may lead to a density reduction equivalent to a foaming grade of 10% or more. It is thus clear that the use of light filler material is an alternative to any disclosed composition herein which is foamed.

The polyvinyl chloride of the suspension grade preferably has a Fikentscher K value between 50 and 65, preferably between 55 and 60, e.g. about 57. Although PVC having such molecular weight may be more expensive than the more prevailing medium and high K value resins, the possibility of incorporating an amount of recycled material in the thus provided substrate layer has an economic and environmental upside. Moreover PVC having a lower K value, as here preferred, may be easier to process in thin and wide layers, and hence more suitable to create a sheet flooring product having a width exceeding 2 m, for example a width of 2.5 m or more. When an amount of recycled PVC is used in the polyvinyl chloride of the suspension grade, this is preferably mixed with virgin PVC having a Fikentscher K value between 50 and 65, preferably between 55 and 60, e.g. about 57. Preferably such mix comprises recycled PVC at a rate of 15 to 75 parts per hundred of the entire PVC resin content. Depending on the origin of the recycled PVC the addition of thereof to the low K value virgin PVC may lead to a rise in the average K value of the mixture. Such rise can be limited by maximally forming 75 phr of the entire PVC resin by recycled PVC material.

Said substrate layer may further comprise filler material, preferably at a rate of 50 to 250 phr, or of 85 to 115 phr, e.g. about 100 phr. Preferably said filler material comprises or consists of limestone, chalk, calcium carbonate or talc.

Said substrate layer may further comprise plasticizer, preferably at a rate of 10 to 200 phr, 20 to 150 phr or 15 to 35 phr. Said plasticizer may be one of the following possibilities or a composition in accordance with one of the following possibilities:
according to a first possibility one or more phthalate-free plasticizers selected from the group consisting of the alkyl esters of cyclohexane dicarboxylic acids and the alkyl esters of aromatic carboxylic acids, preferably with the exception of orthophthalic acid;
according to a second possibility one or more phthalate-free plasticizers selected from the group consisting of alkyl esters of aromatic diacids, benzoates, citrates, phosphates and sulfonates;
according to a third possibility said plasticizer is obtained as a liquid fraction from a solvent extraction process, for example by means of supercritical CO2, performed on industrial, post-industrial or post-consumer PVC scrap;
a mixture of plasticizers from the above first and second possibilities, wherein preferably 5 to 190 phr of plasticizers of said first possibility is used, and preferably 1 to 100 phr of plasticizers of said second possibility.

It is clear that the PVC compositions used for the substrate layer, for example the first and second compositions mentioned above, may further comprise additives such as viscosity reducers, stabilizers, antistatic agents, dyes, pigments, lubricants and processing aids.

Preferably, said substrate layer is provided in an endless length, for example of 50 meter or more, and with a width of 2 to 6 m, preferably of 3 to 5, e.g. about 4 m.

Preferably, said method further comprises the step of providing said decorative top layer.

Preferably, said step of providing said decorative top layer comprises:
the substep of applying a printed pattern on said substrate layer; and/or
the substep of applying a transparent or translucent wear layer on said printed pattern.

Said substep of applying said printed pattern may comprise forming a print directly on said substrate layer, preferably with the intermediate of primer layers, or the lamination of a preprinted decorative film on said substrate layer. The direct forming of the print on said substrate layer, or on said primer layers, may be executed by roller printing and/or by digital application of inks, e.g. by means of an inkjet printing process. In the cases where a preprinted decorative film is used, this may concern a printed polyvinyl chloride film. Preferably said film is opaque and said print is applied at the side of the film that is directed outward the sheet flooring product. Alternatively said film is transparent with said print being applied at the side of the film that is directed inward the sheet flooring product. In such case said film may form at least a portion of a transparent or translucent wear layer.

Said substep of applying said transparent or translucent wear layer on said printed pattern may comprise liquidly applying the material of said transparent or translucent wear layer or the lamination of a prefabricated transparent or translucent film on said printed pattern. The transparent or translucent wear layer may basically be formed from polyvinyl chloride, either plasticized or not, for example with a content of plasticizer of at least 15 phr. Said liquid application may be executed by means of roller application and/or by means of a casting process. As a topmost layer of said transparent or translucent wear layer a lacquer, such as an acrylate, urethane acrylate or polyurethane lacquer, may be applied.

The method of the invention may further comprise the step of applying a textile backing to the side of the substrate layer that is opposite said decorative top layer. The textile backing may be chosen from the list consisting of a polypropylene textile backing, a polyethylene textile backing, a polyethylene terephthalate textile backing, polyvinyl chloride textile backing. Herein the use of polypropylene textile backing is preferred as it delivers excellent walking comfort in combination with straightforward recycling. Since the optimum extrusion temperatures of PVC and PP are not so far apart, they can be extruded together with a minimum risk of malfunctioning of the extruder and/or die. According to a variant the method of the invention may further comprise the step of applying a foamed backing material to the side of the substrate layer that is opposite said decorative top layer. The foamed backing material may for example be a polyethylene foam, such as IXPE (irradiation crosslinked polyethylene), or a polyurethane foam. Preferably said foamed backing material is of the open cell type. According to still another variant the method of the invention may further comprise the step of applying a cork backing material to the side of the substrate layer that is opposite said decorative top layer.

Preferably said method of the first aspect of the invention comprises the step of providing said polyvinyl chloride of the suspension grade. Preferably, said polyvinylchloride of the suspension grade is at least partly obtained by recuperation of PVC from industrial, post-industrial or postconsumer PVC scrap, wherein said recuperation may include an extraction of plasticizer content and/or a grinding or micronisation treatment. Preferably, recuperated PVC with a particle size distribution having a D90 value lower than 500 μm, or lower than 300 μm, is obtained. Preferably said PVC material is obtained by treating said PVC scrap with solvent in order to extract at least a portion of the plasticizer contained therein. As disclosed, by the same applicant, in EP 23177329.2, but not public at the time of filing the present application, a preliminary step of plasticizer extraction by means of solvent renders the PVC scrap more brittle and easier to grind down to a particle size distribution having a D90 value lower than 500 μm, or lower than 300 μm.

In general it is remarked that, wherever for a particle size distribution D90 values are described herein, the particle size distribution may be measured by various techniques known in the art. Particularly, the particle size distribution may be determined by laser granulometry, in particular, the particle size distribution may be determined using laser granulometry, which may be performed in accordance with ISO 13320:2020. This is a dynamic light scattering technique using a laser with an emission wavelength of 632.8 nm, measuring at a scattering angle of 90 degrees. This technique may be performed, for example, with a Malvern® Mastersizer 2000 or with a Malvern® Mastersizer 3000. To perform the measurement of the particle size distribution, the respective particles need to be brought in a loose state, and can be dispersed in a liquid, such as water.

With the same aim as in said first independent aspect, the present invention in accordance with a second independent aspect is a sheet flooring product, wherein said sheet flooring product comprises a substrate layer and a provided thereon decorative top layer, with as a characteristic that said substrate layer comprises polyvinyl chloride of the suspension grade. It is clear that such sheet flooring product may be obtained or may be obtainable through a method in accordance with the first independent aspect of the invention and/or the preferred embodiments thereof, and that the sheet flooring product may show analogous features as disclosed in connection with the flooring products obtained through the method of said first independent aspect.

Preferably, said polyvinyl chloride has a Fikentscher K value between 50 and 65, preferably between 55 and 60, e.g. about 57.

Preferably, said substrate layer comprises or consists of a foamed portion.

Preferably, said substrate layer further comprises filler material, preferably at a rate of 50 to 250 phr, or of 85 to 115 phr, e.g. about 100 phr.

Preferably, said substrate layer further comprises plasticizer, preferably at a rate of 15 to 35 phr.

Preferably, said sheet flooring product is packaged and shipped as a roll.

Preferably, said sheet flooring product has a width of 2 to 6 m, preferably of 3 to 5 m, e.g. of about 4 m.

It is further noted that the present invention in accordance with a third independent aspect also is a die having a slot nozzle opening suitable for extrusion of polyvinyl chloride of the suspension grade, characterized in that said die comprises one or the combination of the following features:
the feature that said die comprises a measurement device for measuring the slot nozzle opening. Such measurement device may make use of the capacitive measuring principle for measuring the distance between the lips bordering the slot nozzle opening, while the material is being extruded;
the feature that said die comprises a, preferably motorized and controlled, mechanism for adjustment of the slot nozzle opening. For example such die may have a slot nozzle opening which is bordered by at least one flexible lip, wherein said flexible lip may be displaced by means of a plurality of actuators along the width of said lip, i.e. in a direction along the width of the slot nozzle opening. Preferably some, i.e. at least two, or all of said actuators may be adjusted independently of one another, such that the flexible lip may be displaced with varying amounts along said width of the slot nozzle opening.

It is clear that the present invention, in an independent manner, also is a method wherein a die in accordance with said third independent aspect is applied for extrusion of a substrate layer of a panel-or sheet shaped floor covering material, or, in other words, a method for manufacturing a decorative panel-or sheet-shaped floor covering material, having at least a substrate layer and a decorative top layer applied thereto, with as a characteristic that at least a portion of said substrate layer is extruded through a die in accordance with said third independent aspect and/or the preferred embodiments thereof. Preferably, the thickness and/or density and/or uniformity of the extruded material leaving the slot nozzle opening is measured, for example using NIR or X-ray. On the basis of the measurement of the thickness and/or density and/or uniformity of the extruded material the slot nozzle opening may be adjusted by an operator, and/or automatically by means of said mechanism for adjustment of the slot nozzle opening.

With the intention of better showing the characteristics of the invention, herein below, as an example without any limitative character, some preferred embodiments are described, with reference to the accompanying drawings, wherein:

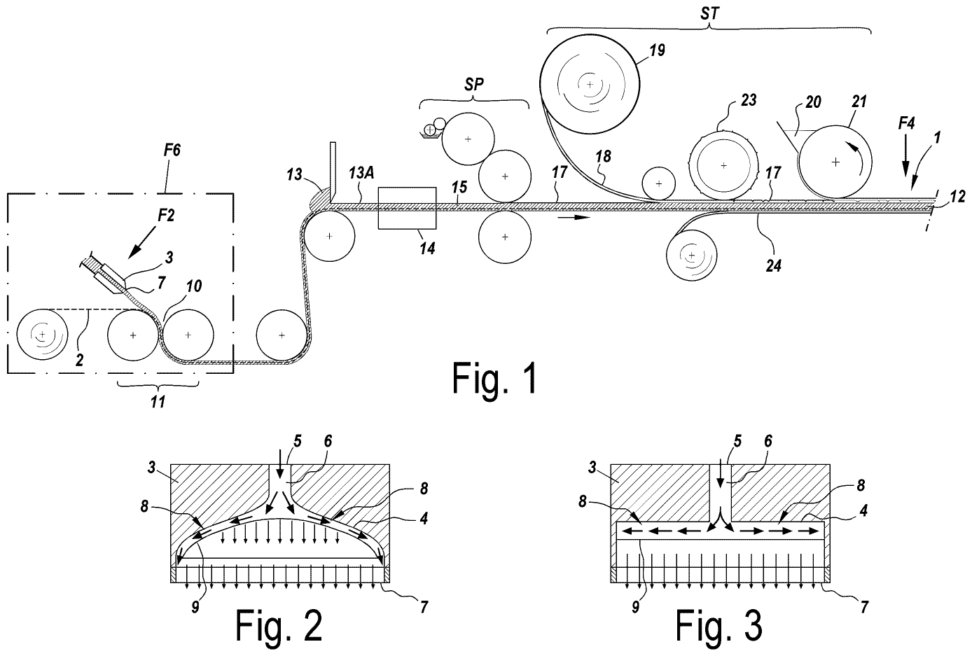

FIG. 1 schematically represents a few steps in a method for manufacturing a sheet flooring product in accordance with the invention;

FIG. 2, at a larger scale, represents a cross-sectional top view of the area indicated with F2 in FIG. 1;

FIG. 3 in a similar view represents an alternative;

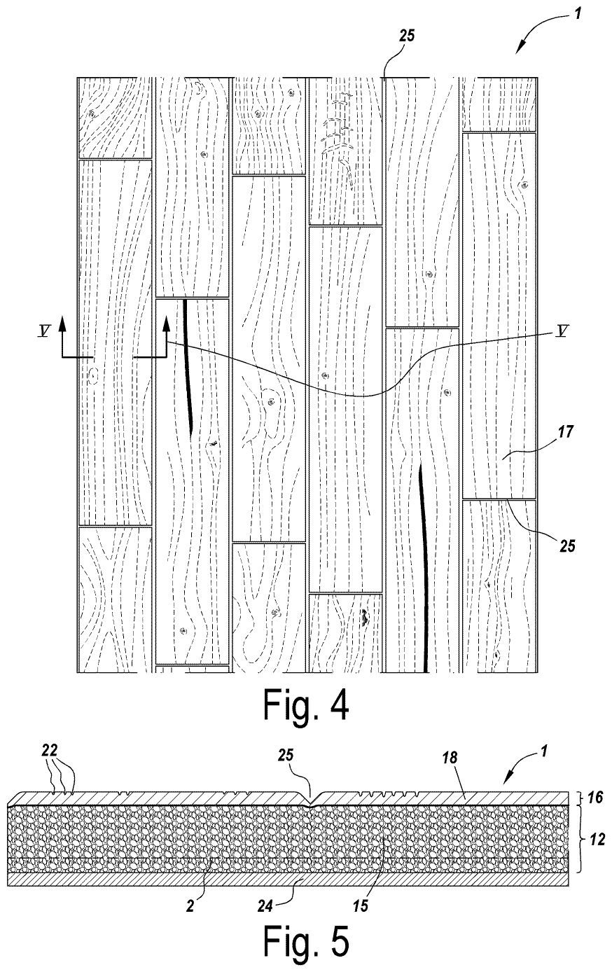

FIG. 4 gives a top view on the area indicated with F4 in FIG. 1;

FIG. 5, at a larger scale, is a cross-section in accordance with line V-V in FIG. 4;

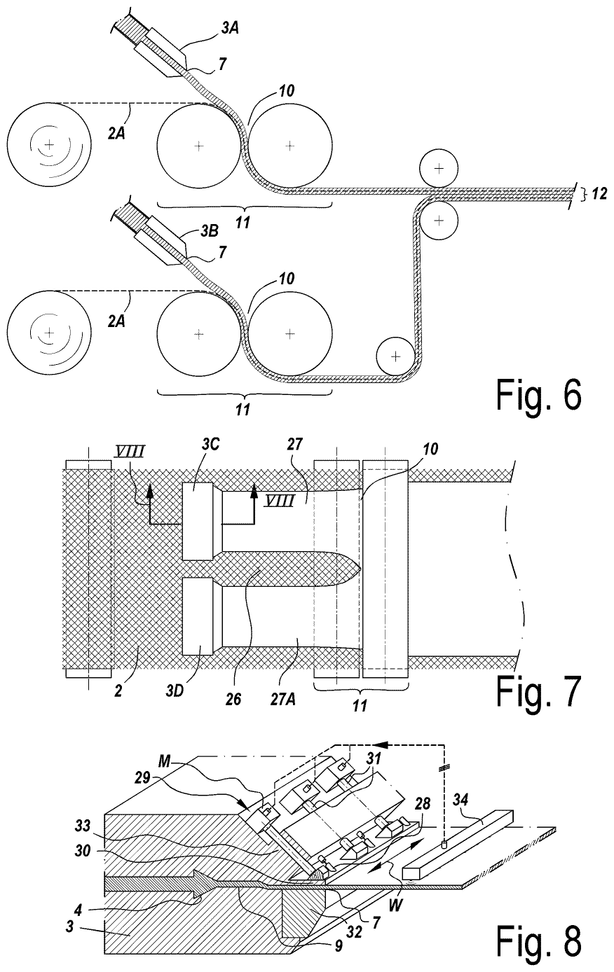

FIG. 6, at a larger scale, represents the area F6, indicated in FIG. 1, but for an alternative;

FIG. 7 is a top view on the same area F6, indicated in FIG. 1, but for a further alternative;

FIG. 8, at a larger scale, shows a cross-section along the lines VIII-VIII indicated in FIG. 7.

FIG. 1 represents a method for manufacturing a sheet flooring product 1. The sheet flooring product 1 comprises a liner 2, and polyvinyl chloride of the suspension grade is being applied on said liner 2 by extruding said polyvinyl chloride through a slot nozzle die 3. In the example the polyvinyl chloride applied comprises a foaming agent, preferably azodicarbonamide.

FIG. 2 shows that said slot nozzle die 3 is of the coat-hanger type, more particularly of the fishtail type. FIG. 3 illustrates an alternative where said slot nozzle die 3 is of the T-type. FIGS. 2 and 3 clearly show that the internal manifold 4 of the respective die are mutually different, i.e. the path taken by the extruded material from the inlet 5 of the die 3, i.e. from the initial extrusion channel 5 connected to the extruder, towards the slot nozzle opening 7. In the T-type die illustrated in FIG. 3, the manifold 4 comprises two arms 8 extending at about 90° angles from the initial extrusion channel 6. These arms 8 have a small slit 9 along their length to allow the polymer melt to flow through towards the slot nozzle opening 7. In the coat-hanger type die illustrated in FIG. 2, the manifold 4 comprises two arms 8 that extend at a shallower angle from the initial extrusion channel 6 and these arms 8 may be straight or curved. In this case, the channels formed by the arms 8 have a diameter tapering down to a smaller radius further from the input channel, and the die 3 may be referred to as a fish tail type die.

FIG. 1 further illustrates that the extruded material is fed through the nip 10 of a set of rollers 11. A calibration of the thickness of the respective portion of the substrate layer 12 may be obtained.

FIG. 1 further illustrates that said step of providing said substrate layer 12 comprises applying a layer 13A of PVC plastisol 13. In this case a doctor application of a PVC plastisol 13 is illustrated. Preferably said plastisol 13 is obtained from polyvinyl chloride of the emulsion grade.

The method illustrated in FIG. 1 further comprises a heat treatment of the polyvinyl chloride applied to said liner 2. Preferably, as illustrated here, said heat treatment is executed by means of a hot-air oven 14. As a result one or more foamed substrate portions 15 may be obtained.

The method, as illustrated here, further comprises the step of providing a decorative top layer 16 on said substrate layer 12. This step comprises the substep SP of applying a printed pattern 17 on said substrate layer 12 and the substep ST of applying a transparent or translucent wear layer 18 on said printed pattern 17. In the example, the printed pattern 17 is applied by means of roller printing, e.g. rotogravure printing, on the applied layer 13A of PVC plastisol 13. The transparent wear layer 18 is applied by thermal lamination of a prefabricated transparent film 19 and liquidly applying a lacquer 20, for example, as illustrated here, by means of one or more rollers 21.

The method further comprises the step of providing embossments or excavations 22 in said transparent wear layer 18. In this case the embossments are obtained at least by mechanically embossing the respective wear layer 18 by means of an embossing roller 23.

The method further comprises the step of applying a textile backing 24 to the side of the substrate layer that is opposite said decorative top layer. The textile backing 24 may be applied to the substrate layer 12 by thermal lamination, by means of glue, or by means of one or more layers of PVC plastisol that are cured in contact with said textile backing 24.

FIG. 4 shows a top view of the obtained sheet flooring product 1. The printed pattern 17 comprised in said decorative top layer 16 comprises the motif of a plurality of adjacent rows of wooden panels.

FIG. 5 clearly illustrates that lowered areas 25 are formed demarcating the depicted wooden panels, in this case at the longitudinal pair of edges as well as on the short pair of edges. Further excavations 22 imitating wood pores have been provided in said transparent wear layer.

FIG. 6 shows an alternative step of providing said polyvinyl chloride of the suspension grade. Herein two serial dies 3A-3B provide for the formation of a substrate layer 12 having substrate sublayers of mutually different composition. Each die applies its extruded PVC composition to a respective liner 2-2A.

FIG. 7 shows an alternative embodiment where the step of providing said polyvinyl chloride of the suspension grade is executed with two parallel dies 3C-3D. A substrate layer having the width of at least the sum of the widths of the respective slot nozzle openings 7 may be formed. In the example, a void 26 between, adjacent edges of parallelly extruded layers is firstly obtained and subsequently levelled out. The parallelly extruded layers 27-27A are fed in the nip 10 formed by at least two rollers 11, for example in order to be calibrated. Said two parallel dies 3C-3D deposit the extruded material on a common liner 2.

FIG. 8 illustrates that a die 3 in accordance with the third independent aspect mentioned in the introduction may be used. The illustrated die 3 comprises a measurement device 28 for measuring the slot nozzle opening 7 and a motorized and controlled mechanism 29 for adjustment of the slot nozzle opening 7.

As shown, the die 3 may have a slot nozzle opening 7 which is bordered by at least one flexible lip 30, wherein said flexible lip 30 may be displaced by means of a plurality of actuators 31 along the width of said lip 30, i.e. in a direction W along the width of the slot nozzle opening 7. Preferably some, i.e. at least two, or all of said actuators 31 may be adjusted independently of one another, such that the flexible lip 30 may be displaced with varying amounts along said width W of the slot nozzle opening 7. Each actuator 31 may be driven by a motor M.

The measurement device 28 may make use of the capacitive and/or inductive measuring principle for directly or indirectly measuring the distance between the lips 30-32 bordering the slot nozzle opening 7, while the material is being extruded. As illustrated, the measurement is indirect and the distance between the flexible lip 30 and a fixed part 33 of the die 3 is measured by means of one or more measurement devices 28 spread along the width W of said flexible lip 30.

FIG. 8 further illustrates that the thickness and/or density and/or uniformity of the extruded material leaving the slot nozzle opening 7 is measured, for example using a device 34 allowing NIR or X-ray measurement. On the basis of the measurement of the thickness and/or density and/or uniformity of the extruded material the slot nozzle opening 7 may be adjusted automatically by means of said mechanism 29 for adjustment of the slot nozzle opening 7.

The present invention is not limited to the preferred embodiments described here above, but such methods and sheet flooring products may be realized according to several variants without leaving the scope of the invention.

1.-27. (canceled)

28. A method for manufacturing a sheet flooring product, wherein said sheet flooring product comprises a substrate layer and a provided thereon decorative top layer,
wherein said method at least comprises the step of providing said substrate layer on the basis of polyvinyl chloride of the suspension grade.

29. The method according to claim 28, wherein said sheet flooring product comprises a liner,
wherein said step of providing said substrate layer comprises applying said polyvinyl chloride of the suspension grade on said liner.

30. The method according to claim 28, wherein said step of providing said substrate layer comprises extruding said polyvinyl chloride of the suspension grade through a slot nozzle die.

31. The method according to claim 28, wherein said step of providing said substrate layer comprises feeding at least a portion of said substrate layer through the nip of a set of rollers.

32. The method according to claim 28, wherein said substrate layer comprises a foamed portion.

33. The method according to claim 32, wherein said polyvinyl chloride of the suspension grade comprises a blowing agent.

34. The method according to claim 32, wherein said step of providing said substrate layer comprises a heat treatment of said substrate layer.

35. The method according to claim 28, wherein said polyvinyl chloride of the suspension grade has a Fikentscher K value between 50 and 65.

36. The method according to claim 28, wherein said substrate layer further comprises filler material.

37. The method according to claim 28, wherein said substrate layer further comprises plasticizer.

38. The method according to claim 28, wherein said substrate layer is provided in an endless length and with a width of 2 to 6 m.

39. The method according to claim 28, wherein said method further comprises the step of providing said decorative top layer.

40. The method according to claim 39, wherein said step of providing said decorative top layer comprises:
the substep of applying a printed pattern on said substrate layer; and
the substep of applying a transparent or translucent wear layer on said printed pattern.

41. The method according to claim 40, wherein said substep of applying said printed pattern comprises forming a print directly on said substrate layer or the lamination of a preprinted decorative film on said substrate layer.

42. The method according to claim 28, wherein said method further comprises the step of applying a textile backing to the side of the substrate layer that is opposite said decorative top layer.

43. The method according to claim 28, wherein said method at least comprises the step of providing said polyvinyl chloride of the suspension grade,
wherein said polyvinylchloride of the suspension grade is at least partly obtained by recuperation of PVC from industrial, post-industrial or postconsumer PVC scrap,
wherein said recuperation may include an extraction of plasticizer content and/or a grinding or micronisation treatment.

44. A sheet flooring product, wherein said sheet flooring product comprises a substrate layer and a provided thereon decorative top layer,
wherein said substrate layer comprises polyvinyl chloride of the suspension grade.

45. The sheet flooring product according to claim 44, wherein said polyvinyl chloride has a Fikentscher K value between 50 and 65.

46. The sheet flooring product according to claim 44, wherein said substrate layer comprises or consists of a foamed portion.

47. The sheet flooring product according to claim 44, wherein said substrate layer further comprises filler material.
